(19) United States
(12) Patent Application Publication
(10) Pub. No.: US 2026/0306983 A1
(43) Pub. Date: Oct. 8, 2026

(54) AUTOMOTIVE AIR FILTERS WITH HYDROCARBON-ABSORBING MEDIA

(71) Applicant: Green Filter USA, Inc., Mt. Braddock, PA (US)

(72) Inventor: Mark K. German, Canonsburg, PA (US)

(21) Appl. No.: 19/640,036

(22) Filed: Apr. 6, 2026

Related U.S. Application Data
(60) Provisional application No. 63/783,445, filed on Apr. 4, 2025.
(60) Provisional application No. 63/972,268, filed on Jan. 30, 2026.

(51) Int. Cl. B01D 46/00; B01D 46/52; B01D 53/02

(52) U.S. Cl. CPC B01D 46/0036; B01D 46/521; B01D 53/02; B01D 2253/102; B01D 2257/702; B01D 2275/201; B01D 2279/60

(57) ABSTRACT

An automotive air filter assembly includes a base, a primary filter attached to the base, an end cap attached opposite the base, and a hydrocarbon trap comprising hydrocarbon trap media positioned in the primary filter or within an internal volume of the primary filter. The hydrocarbon trap media may comprise activated carbon and is positioned to contact backflow gas from an engine and adsorb hydrocarbon vapors during backflow conditions, including after engine shut-off. In some embodiments, the primary filter includes a first primary filter section and a second primary filter section separated by a connector ring.

### CROSS-REFERENCE TO RELATED APPLICATION

This application claims the benefit of U.S. Provisional Patent Application No. 63/783,445 filed Apr. 4, 2025, and also claims the benefit of U.S. Provisional Patent Application No. 63/972,268 filed Jan. 30, 2026, both of which are incorporated herein by reference.

### FIELD OF THE INVENTION

The disclosed subject matter relates to automotive air filter assemblies including hydrocarbon trap media for adsorption of hydrocarbon vapors.

### BACKGROUND INFORMATION

Automobiles rely on air filtration systems to reduce entry of particulates and other contaminants into engine intake systems. Air filters may have cylindrical, conical, planar, triangular, or other configurations. Hydrocarbon vapors may be present during engine backflow conditions, including after engine shut-off, and there remains a need for air filter assemblies configured to reduce hydrocarbon emissions while maintaining particulate filtration performance.

### SUMMARY OF THE INVENTION

Disclosed embodiments provide an automotive air filter assembly including a base structured and arranged for connection to an engine, a primary filter attached to the base, an end cap attached to the primary filter opposite the base, and a hydrocarbon trap comprising hydrocarbon trap media positioned in the primary filter or within an internal volume of the primary filter. The hydrocarbon trap is positioned to contact backflow gas from the engine and adsorb hydrocarbon vapors contained in the backflow.

In some embodiments, the hydrocarbon trap media comprises activated carbon, inorganic adsorbents, organic adsorbents, or a combination thereof. In some embodiments, activated carbon is provided in the form of granular activated carbon, pelletized activated carbon, activated carbon fibers, activated carbon powder, or combinations thereof. In some embodiments, activated carbon is incorporated into hydrocarbon trap media and/or into at least a portion of primary filter media by coating, impregnation, adherence to fibers, co-extrusion with fibers, or other incorporation techniques.

In some embodiments, the primary filter includes a first primary filter section and a second primary filter section separated by a connector ring. One or both of the first primary filter section and the second primary filter section may include activated carbon or another hydrocarbon-absorbing material. The relative lengths of the first primary filter section and the second primary filter section may be selected to tailor particulate filtration performance, hydrocarbon adsorption performance, surface area, pressure drop, and packaging for a particular engine intake application.

In some embodiments, the end cap comprises an annular cap end wall, an inner annular ring, and an end cap central opening. In some embodiments, the hydrocarbon trap is attached to the end cap and extends within the internal volume of the primary filter. In other embodiments, the end cap is solid and extends over the primary filter and the hydrocarbon trap. The automotive air filter assembly may be installed in an airbox or in an open filter installation without an enclosed airbox.

An aspect of the present invention is to provide an automotive air filter assembly comprising a base structured and arranged for connection to an engine, a primary filter attached to the base, an end cap attached to the primary filter opposite the base, and a hydrocarbon trap comprising hydrocarbon trap media positioned in the primary filter or within an internal volume of the primary filter structured and arranged to contact backflow gas from the engine and absorb hydrocarbon vapors contained in the backflow.

Another aspect of the present invention is to provide a method of reducing hydrocarbon emissions associated with an engine intake system. The method comprises passing backflow gas from the engine to an automotive air filter assembly as described above having a hydrocarbon trap to thereby absorb hydrocarbon vapors contained in the backflow gas.

These and other aspects of the present invention will be more apparent from the following description.

### BRIEF DESCRIPTION OF THE DRAWINGS

FIG. 1 is a perspective view of an automotive air filter assembly in accordance with an embodiment of the invention.

FIG. 2A is a sectional side view of the automotive air filter assembly of FIG. 1.

FIG. 2B is a sectional side view illustrating airflow paths and dimensional parameters for the automotive air filter assembly of FIG. 1.

FIG. 3 is a perspective view of an automotive air filter assembly having a generally conical primary filter in accordance with another embodiment of the invention.

FIG. 4 is a perspective view of an automotive air filter assembly having first and second primary filter sections in accordance with another embodiment of the invention.

FIG. 5 is a sectional side view of the automotive air filter assembly of FIG. 4.

FIG. 6 is a perspective view of an automotive air filter assembly having first and second primary filter sections in accordance with another embodiment of the invention.

FIG. 7A is a sectional side view of an automotive air filter assembly in accordance with another embodiment of the invention.

FIG. 7B is a sectional side view illustrating airflow paths and dimensional parameters for the automotive air filter assembly of FIG. 7A.

### DETAILED DESCRIPTION

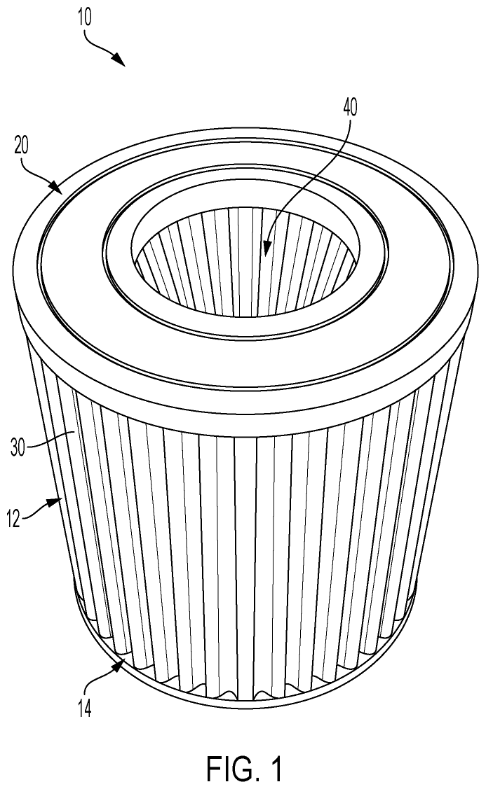

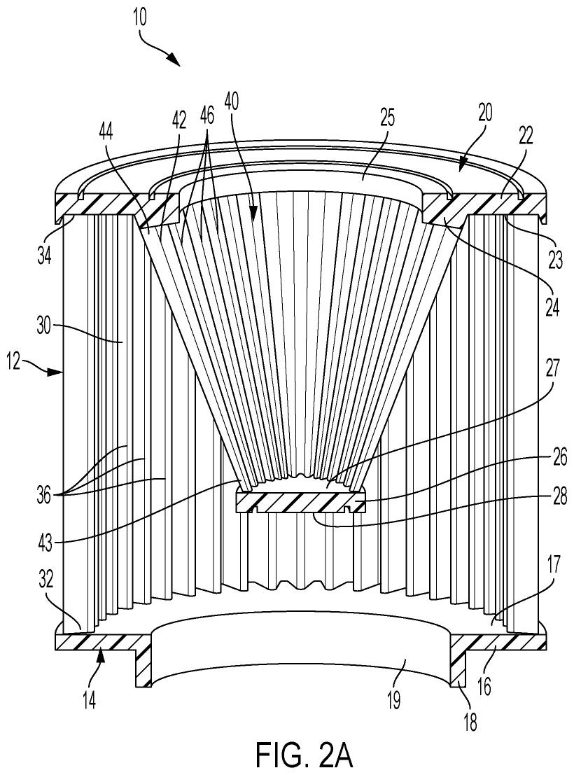

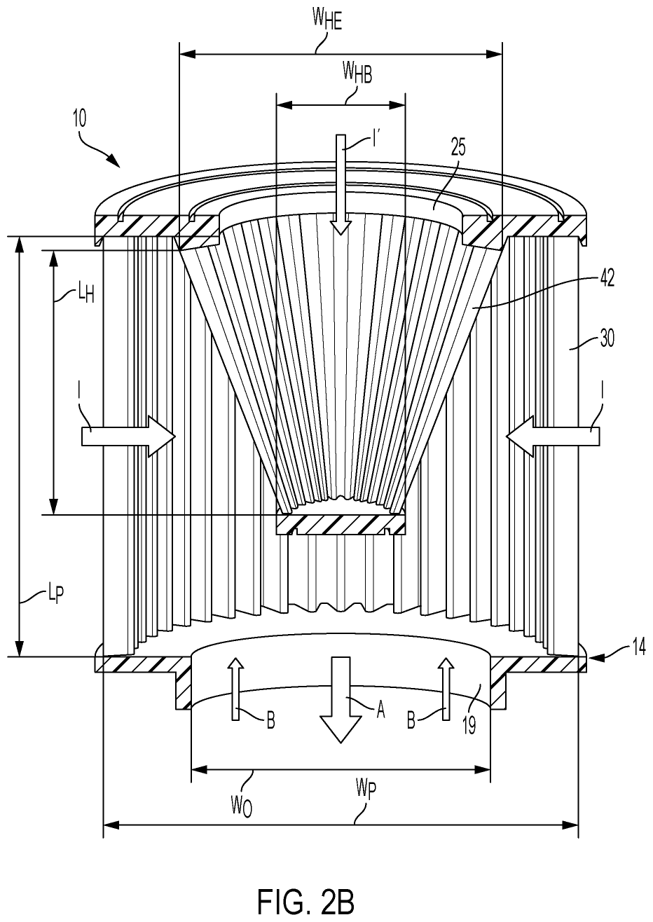

FIGS. 1, 2A and 2B illustrate an air filter assembly 10 including a primary filter 12, base 14, end cap 20, primary filter media 30, and hydrocarbon trap 40. As shown most clearly in FIG. 2A, the base 14 includes an annular base end wall 16 having an interior surface 17, a sealing gasket 18, and a base opening 19. The end cap 20 includes an annular cap endwall 22 having an interior surface 23, inner annular ring 24, and end cap central opening 25. As further shown in FIG. 2A, the air filter assembly 10 includes an interior cap 26 having a first surface 27 facing toward the end cap 20 and a second surface 28 facing toward the base 14.

The primary filter media 30 has a base end 32, end cap end 34, and filter pleats 36. The filter pleats 36 extend from the base 14 to the end cap 20. The primary filter media 30 may be made of a pleated filter material to increase surface area and capture airborne debris. The primary filter 12 may be generally cylindrical as shown in FIGS. 1, 2A and 2B, or may be generally conical, planar, rectangular, triangular, or any other suitable shape. The primary filter media 30 may comprise any suitable filter material, including corrugated filter materials comprising cotton.

The hydrocarbon trap 40 includes a hydrocarbon trap media 42 such as a filter media, a base end 43, and an end cap end 44. The hydrocarbon trap media 42 includes multiple pleats 46 that extend from the inner annular ring 24 of the end cap 20 to the first surface 27 of the interior cap 26. The hydrocarbon trap 40 may be provided in the form of a second filter positioned downstream from a normal intake-air flow direction through the primary filter 12, such that hydrocarbon vapors contained in engine backflow gas contact the hydrocarbon trap media 42. The hydrocarbon trap 40 may be provided inside the primary filter 12. The hydrocarbon trap 40 may be generally conical, generally cylindrical, planar, rectangular, triangular, or any other suitable shape. The hydrocarbon trap media 42 may be pleated as shown, and may alternatively be provided in the form of a pouch, bag, cartridge, insert, or the like.

The hydrocarbon trap 40 may be installed within the internal volume of the primary filter 12 in any suitable manner. Non-limiting examples include bonding to the end cap 20, coupling to the base 14 near the base opening 19, mechanical retention using one or more tabs, ribs, or interference features, incorporation into a pleated assembly with the primary filter 12, or friction fit and/or removable engagement to facilitate replacement.

The hydrocarbon trap media 42 may comprise any suitable hydrocarbon-absorbing material, including activated carbon, inorganic adsorbents, organic adsorbents, or a combination thereof. The hydrocarbon trap media 42 may comprise activated carbon in any suitable form, including granular activated carbon, pelletized activated carbon, activated carbon fibers, and activated carbon powder. The activated carbon may be applied to, impregnated into, or otherwise combined with a substrate to provide a desired pleated configuration. The activated carbon may be co-extruded with fibers of the hydrocarbon trap media 42 into fiber bundles. The activated carbon may be coated on fibers of the hydrocarbon trap media 42. The activated carbon may be adhered to fibers of the hydrocarbon trap media 42. The activated carbon may be impregnated into the hydrocarbon trap media 42. The primary filter media 30 may also be provided with activated carbon or other hydrocarbon-absorbing materials on an inner portion and/or an outer portion of the primary filter media 30.

The base 14 may comprise a pre-formed component configured to provide structural support and to couple the air filter assembly 10 to an engine intake. In some embodiments, the base 14 comprises an injection molded thermoplastic material. In some embodiments, the base 14 comprises a thermoplastic polyurethane. The base 14 may define a bonding surface configured to receive the base end 32 of the primary filter media 30 and to retain the base end 32 using an adhesive.

The sealing gasket 18 of the base 14 may be configured to form a seal between the air filter assembly 10 and an associated intake component of a vehicle (not shown). In some embodiments, the sealing gasket 18 comprises an elastomeric material selected to reduce leakage around the base opening 19 and to help maintain a desired airflow path through the air filter assembly 10. The base opening 19 may define a flow opening through which filtered air passes toward an engine intake, and the base 14 and sealing gasket 18 together may help provide a secure mounted connection of the air filter assembly 10 within an engine intake system.

The end cap 20 may comprise a pre-formed component configured to provide structural support at an axial end of the primary filter media 30 opposite the base 14. In some embodiments, the end cap 20 comprises an injection molded thermoplastic material. In some embodiments, the end cap 20 comprises a thermoplastic polyurethane. The end cap 20 may define a bonding surface configured to receive the end cap end 34 of the primary filter media 30 and to retain the end cap end 34 using an adhesive.

As shown in FIGS. 1, 2A and 2B, the annular cap end wall 22 may extend partially over an axial end of the primary filter media 30, and the inner annular ring 24 may provide a mounting and support region for the hydrocarbon trap 40. In some embodiments, the end cap end 44 of the hydrocarbon trap media 42 is coupled to the inner annular ring 24 such that the hydrocarbon trap 40 is suspended within the internal volume of the primary filter 12. The end cap central opening 25 may be defined radially inward of the annular cap end wall 22 and may provide an inlet path for secondary airflow to pass into and through the hydrocarbon trap 40, as more fully described below.

As shown in FIG. 2B, during operation, the air filter assembly 10 draws in a primary airflow I through the primary filter media 30, and draws in a secondary airflow I′ through the end cap central opening 25 and through the hydrocarbon trap media 42. After the primary and secondary airflows I and I′ enter the interior of the primary filter media 30, the filtered air is provided as an engine air supply A directed toward an engine (not shown) of a vehicle in which the air filter assembly 10 is installed.

As further shown in FIG. 2B, the air filter assembly 10 includes the following dimensions: primary filter length L_{P}, hydrocarbon trap length L_{H}, primary filter width W_{P}, base opening width W_{O}, hydrocarbon trap base width W_{HB} and hydrocarbon trap end cap width W_{HE}. In some embodiments, the hydrocarbon trap length L_{H} is from 10 to 100 percent of the primary filter length L_{P}, for example, from 20 to 90 percent, or from 40 to 80 percent, or from 50 to 75 percent. In some embodiments, the width adjacent to the end cap W_{HE} is from 20 to 100 percent of the primary filter width W_{P}, for example, from 20 to 95 percent, or from 40 to 90 percent, or from 50 to 80 percent. In some embodiments, the width adjacent to the base W_{HB} is from 5 to 80 percent of the primary filter width W_{P}, for example, from 10 to 75 percent, or from 20 to 50 percent. In the embodiment shown, the hydrocarbon trap 40 is generally conical, i.e., the width adjacent to the base W_{HB} may be smaller than the width adjacent to the end cap W_{HE}. The width hydrocarbon trap 40 hydrocarbon trap adjacent to the end cap W_{HE} may be from 50 to 200 percent of the primary filter base opening width W_{O}, for example, from 75 to 150 percent.

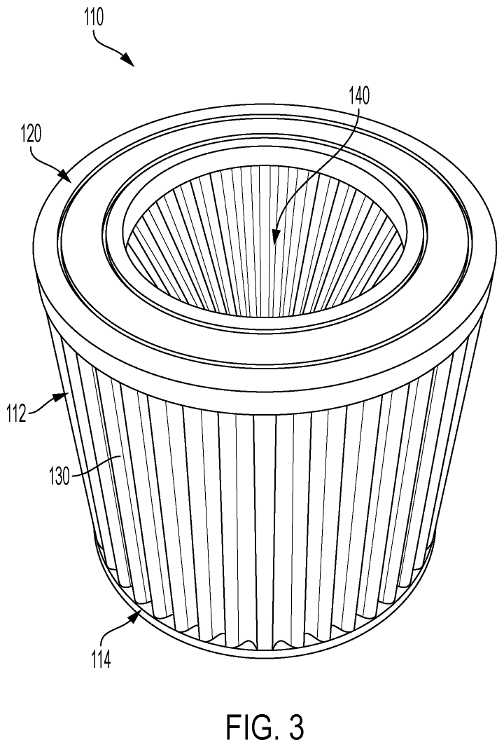

FIG. 3 illustrates another air filter assembly 110 including a primary filter 112, base 114, end cap 120, primary filter media 130, and hydrocarbon trap 140. The air filter assembly 110 of FIG. 3 comprises similar structural features as shown in FIGS. 1, 2A and 2B, but with the primary filter 112 being slightly conical rather than cylindrical, and the end cap 120 having a slightly smaller outer diameter in comparison with an outer diameter of the base 114.

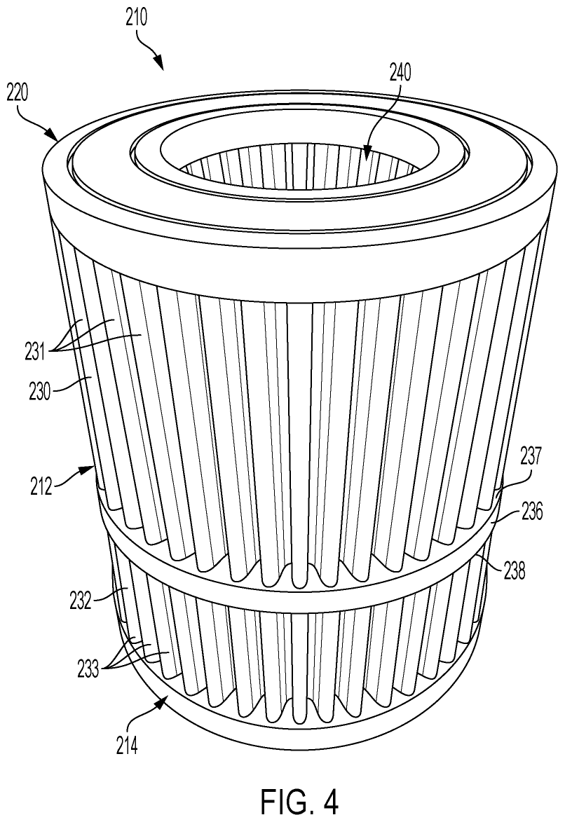

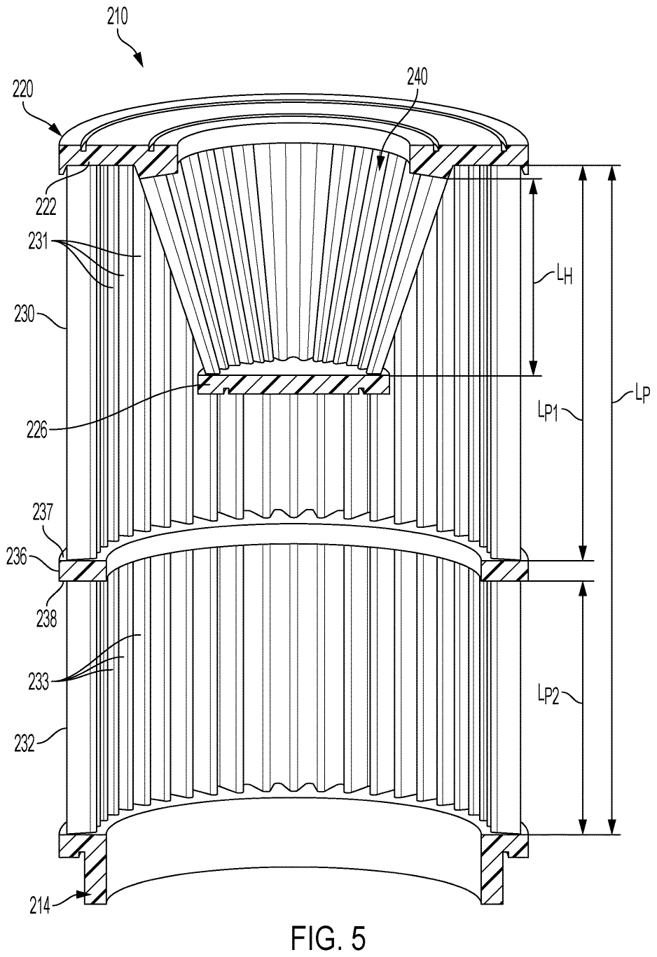

FIGS. 4 and 5 illustrate an air filter assembly 210 similar to the embodiment shown in FIGS. 1, 2A and 2B but with the primary air filter 212 being divided into multiple sections. Specifically, the air filter assembly 210 includes a primary filter 212, base 214, end cap 220, and hydrocarbon trap 240. The hydrocarbon trap 240 may be similar to the hydrocarbon trap 40 described above and shown in FIGS. 1, 2A and 2B. The primary filter 212 includes a first primary filter section 230 and a second primary filter section 232. As more fully described below, at least one of the first and second primary filter sections 230 and 232 may comprise hydrocarbon trap media, in which case the hydrocarbon trap 240 may be eliminated or may act as an additional hydrocarbon absorbing material. The first primary filter section 230 includes first primary air filter pleats 231, and the second primary filter section 232 includes second primary filter pleats 233. A connector ring 236 is provided between the first and second primary filter sections 230 and 232, and includes a first surface of the connector ring 237 contacting the first primary air filter pleats 231 and a second surface 238 of the connector ring contacting the second primary filter pleats 233.

The first primary filter section 230 may comprise a conventional particulate filtration material, a standard filter material, or another intake-air filtration material configured to capture airborne debris. Alternatively, the first primary filter section 230 may comprise hydrocarbon trap media as described above, in which case the hydrocarbon trap may be part of the primary filter. The first primary filter section 230 may define a selected axial portion of the primary filter 212 and may have a length L_{P1} selected to provide a desired balance of filtration area, airflow, and structural support.

The second primary filter section 232 may comprise a conventional particulate filtration material, a standard filter material and/or hydrocarbon trap media as described above such as a filtration material provided with activated carbon or another hydrocarbon-absorbing material, in which case the hydrocarbon trap may be part of the primary filter. The second primary filter section 232 may define a selected axial portion of the primary filter 212 and may have a length L_{P2} that is the same as or different from the length L_{P1} of the first primary filter section 230.

The first primary filter section 230 and the second primary filter section 232 together form the primary filter 212 having a total length L_{P}. As shown in FIG. 5, the first primary filter section has a length L_{P1}, the second primary filter section has a length L_{P2}, and in some embodiments the length L_{P2} may be from 10 to 90 percent of the length L_{P1}, for example, from 20 to 80 percent. Each of the first and second primary filter section lengths L_{P1} and L_{P2} may be from 0 to 100 percent of the total length L_{P}, for example, from 10 to 90 percent, or from 20 to 80 percent.

The connector ring 236 may comprise a pre-formed component configured to couple the first primary filter section 230 to the second primary filter section 232 in a stacked axial arrangement. In some embodiments, the connector ring 236 comprises an injection molded thermoplastic material. In some embodiments, the connector ring 236 comprises a thermoplastic polyurethane. The connector ring 236 may define one or more bonding surfaces configured to receive adjacent axial ends of the first primary filter section 230 and the second primary filter section 232 and to retain the adjacent axial ends using an adhesive. The connector ring 236 may also provide structural reinforcement, maintain relative alignment of the first primary filter section 230 and the second primary filter section 232, and permit use of different filtration materials and/or different media characteristics in different axial portions of the primary filter 212.

A suitable thermoplastic polyurethane material for injection molding to form the base 14, the end cap 20 and the connector ring 236 is sold under the designation TEXIN 245 by Bayer Material Science Company. It is an aromatic polyester-based thermoplastic polyurethane with a shore hardness of about 45D.

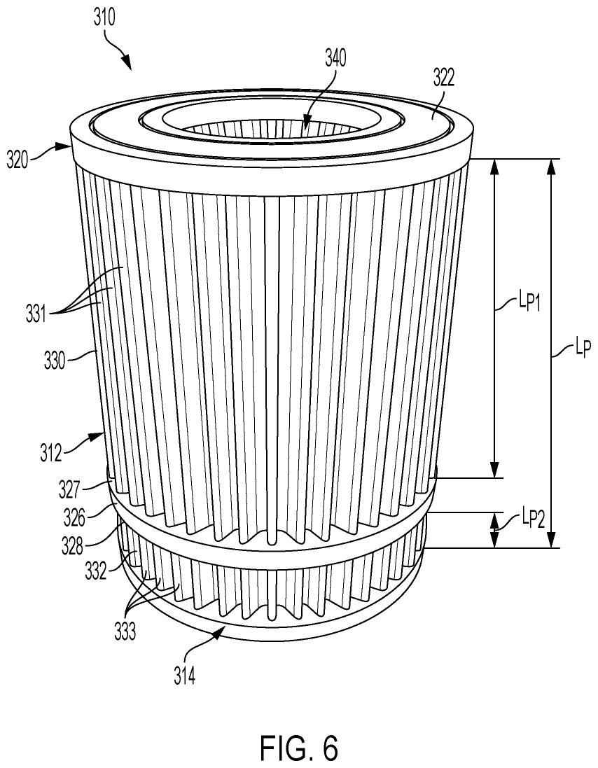

FIG. 6 illustrates another air filter assembly 310 including a primary filter 312, base 314, end cap 320, and hydrocarbon trap 340. Similar to the embodiment shown in FIGS. 4 and 5, the air filter assembly 310 of FIG. 6 includes multiple primary filter sections in the form of a first primary filter section 330 having first primary air filter pleats 331, and a second primary air filter section 332 having second primary air filter pleats 333. The first and second primary air filter sections 330 and 332 may comprise similar materials as the air filter assembly 210 described above. When the first and/or second primary air filter section 330 and 332 comprise a hydrocarbon trap media, the hydrocarbon trap 340 may be eliminated or may act as an additional hydrocarbon absorbing material. A connector ring 326 having first and second surfaces 327 and 328 is located between the first primary filter section 330 and second primary filter section 332. In FIG. 6, the total length of the primary filter L_{P}, the length of the first primary filter section L_{P1}, and the length of the second primary filter section L_{P2} are labeled. However, in the embodiment of FIG. 6, the second primary filter section length L_{P2} is substantially less than the first primary filter section length L_{P1}.

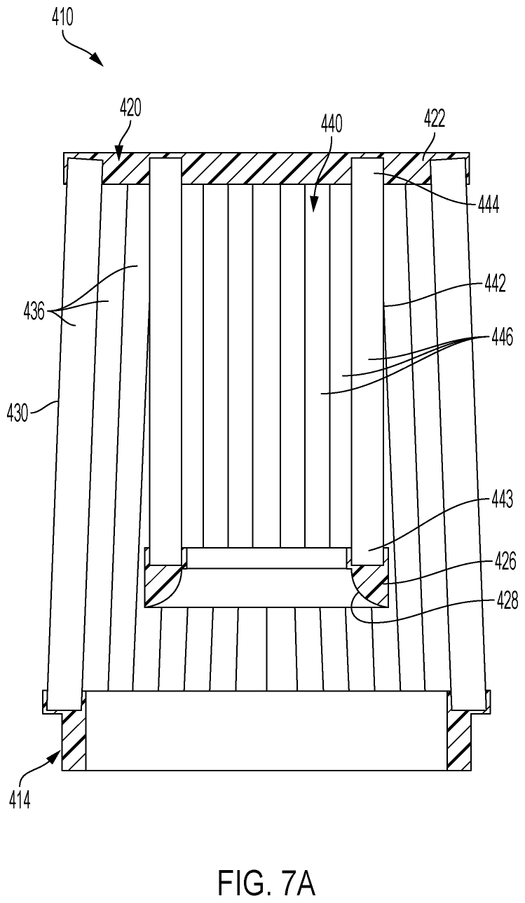

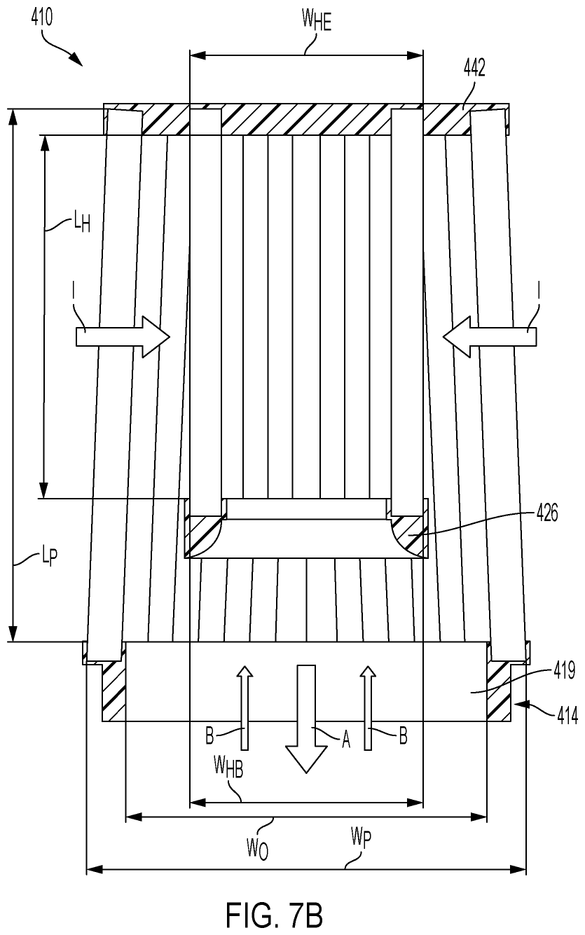

FIGS. 7A and 7B illustrate another air filter assembly 410 including a base 414, end cap 420, primary filter media 430 and hydrocarbon trap 440. In this embodiment, the end cap 420, the primary filter media 430 includes filter pleats 436. The hydrocarbon trap 440 includes a hydrocarbon filter media 442 including pleats 446. The hydrocarbon trap 440 includes a base end 443 and end cap end 444. An interior end ring 426 is connected to an interior end 443 of the hydrocarbon filter media 442 and includes a central opening 428. The interior end ring opening 428 of the interior end ring 426 is aligned with the base opening 419 of the base 414.

As shown in FIG. 7B, the air filter assembly 410 has a primary air inflow I and engine air supply A. Backflow gas B may pass into the interior volume of the air filter assembly 410 where it contacts the hydrocarbon trap 440.

As further shown in FIG. 7B, the air filter assembly 410 includes a primary filter length L_{P}, hydrocarbon trap length L_{H}, primary filter width W_{P}, and base opening width W_{O}. The hydrocarbon trap 440 has a width adjacent to the end cap W_{HE}, and a width adjacent to the hydrocarbon trap base W_{HB}.

In some embodiments, the hydrocarbon trap 440 has a width adjacent to the end cap W_{HE} and/or a width adjacent to the base W_{HB} selected relative to the primary filter width WP and the base opening width W_{O} to provide a desired balance of hydrocarbon adsorption surface area, airflow, pressure drop, and packaging. In some embodiments, the width adjacent to the end cap W_{HE} is from 10 to 90 percent of the primary filter width W_{P}, and the width adjacent to the base W_{HB} is from 10 to 100 percent of the primary filter width W_{P}.

In the embodiment of FIGS. 7A and 7B, the end cap 420 includes a circular cap end wall 422 extending across an axial end of the primary filter media 430 and the hydrocarbon trap 440. The interior end ring 426 is connected to the base end 443 of the hydrocarbon trap media 442 and defines the central opening 428. In some embodiments, the central opening 428 is aligned with the base opening 419 such that airflow and/or backflow gas entering from the base side is directed toward the hydrocarbon trap 440. This arrangement may position the hydrocarbon trap 440 to receive backflow gas B from the engine side while the opposite end cap end 444 remains closed by the end cap 420.

The air filter assemblies may provide manufacturing and performance advantages. By using preformed components with a cured adhesive layer to secure the filter media, manufacturing throughput may be increased because only the adhesive layer cures during assembly. The use of preformed components may also reduce the risk of filter media pull-away associated with demolding of thick thermoset parts. Thermoplastic components may also be recyclable relative to conventional thermoset structures.

Positioning a hydrocarbon trap within the internal volume of the primary filter, and/or incorporating a hydrocarbon-absorbing material into at least a portion of the primary filter media, can reduce hydrocarbon emissions by adsorbing fuel vapors during backflow events while preserving particulate filtration performance during normal intake airflow.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. An automotive air filter assembly comprising:
a base structured and arranged for connection to an engine;
a primary filter attached to the base;
an end cap attached to the primary filter opposite the base; and
a hydrocarbon trap comprising hydrocarbon trap media positioned in the primary filter or within an internal volume of the primary filter structured and arranged to contact backflow gas from the engine and absorb hydrocarbon vapors contained in the backflow.

2. The automotive air filter assembly of claim 1, wherein the hydrocarbon trap comprises filter media.

3. The automotive air filter assembly of claim 2, wherein the filter media comprises activated carbon, inorganic adsorbents, organic adsorbents, or a combination thereof.

4. The automotive air filter assembly of claim 3, wherein the filter media comprises activated carbon comprising one or more of granular activated carbon, pelletized activated carbon, activated carbon fibers, and activated carbon powder.

5. The automotive air filter assembly of claim 4, wherein the activated carbon is provided in the form of co-extruded activated carbon with fibers of the filter media, activated carbon coated on fibers of the filter media, activated carbon adhered to fibers of the filter media, activated carbon impregnated into the filter media, or a combination thereof.

6. The automotive air filter assembly of claim 2, wherein the filter media comprises woven or non-woven material.

7. The automotive air filter assembly of claim 6, wherein the filter media comprises activated carbon in and/or on fibers of the woven or non-woven material.

8. The automotive air filter assembly of claim 1, wherein the hydrocarbon trap is attached to the end cap.

9. The automotive air filter assembly of claim 1, wherein the hydrocarbon trap is fixed within the internal volume of the primary filter.

10. The automotive air filter assembly of claim 1, wherein the hydrocarbon trap is removably retained within the internal volume of the primary filter.

11. The automotive air filter assembly of claim 1, wherein the primary filter is generally cylindrical or generally conical.

12. The automotive air filter assembly of claim 1, wherein the hydrocarbon trap is generally conical.

13. The automotive air filter assembly of claim 1, wherein the hydrocarbon trap is generally cylindrical.

14. The automotive air filter assembly of claim 1, wherein the end cap comprises an annular cap end wall, an inner annular ring of the annular cap end wall contacting the hydrocarbon trap, and an end cap central opening.

15. The automotive air filter assembly of claim 1, wherein the end cap is solid and extends over the primary filter and the hydrocarbon trap.

16. The automotive air filter assembly of claim 1, wherein the primary filter has a length L_{P}, the hydrocarbon trap has a length L_{H}, and the hydrocarbon trap length L_{H} is from 10 to 100 percent of the primary filter length L_{P}.

17. The automotive air filter assembly of claim 16, wherein the hydrocarbon trap length L_{H} is from 20 to 90 percent of the primary filter length L_{P}.

18. The automotive air filter assembly of claim 1, wherein the primary filter has a width W_{P}, the hydrocarbon trap has a width adjacent to the end cap W_{HE}, and the hydrocarbon trap width adjacent to the end cap W_{HE} is from 10 to 90 percent of the primary filter width W_{P}.

19. The automotive air filter assembly of claim 18, wherein the hydrocarbon trap width adjacent to the end cap W_{HE} is from 20 to 70 percent of the primary filter width W_{P}.

20. The automotive air filter assembly of claim 1, wherein the primary filter has a width W_{P}, the hydrocarbon trap has a width adjacent to the base W_{HB}, and the hydrocarbon trap width adjacent to the base W_{HB} is from 10 to 100 percent of the primary filter width W_{P}.

21. The automotive air filter assembly of claim 20, wherein the hydrocarbon trap width adjacent to the base W_{HB} is from 20 to 80 percent of the primary filter width W_{P}.

22. The automotive air filter assembly of claim 1, wherein the base comprises a base opening having a width W_{O}, the hydrocarbon trap has a width adjacent to the end cap W_{HE}, and W_{HE} is from 50 to 200 percent of W_{O}.

23. The automotive air filter assembly of claim 1, wherein the primary filter comprises a first primary filter section and a second primary filter section, and at least one of the first primary filter section and the second primary filter section comprises the hydrocarbon trap media.

24. The automotive air filter assembly of claim 23, wherein the first primary filter section has a length L_{P1}, the second primary filter section has a length L_{P2}, and the length L_{P2} is from 10 to 90 percent of the length L_{P1}.

25. The automotive air filter assembly of claim 1, wherein the hydrocarbon trap media is provided in the primary filter.

26. A method of reducing hydrocarbon emissions associated with an engine intake system, the method comprising passing backflow gas from the engine to the hydrocarbon trap of the automotive air filter assembly of claim 1 to absorb hydrocarbon vapors contained in the backflow gas.
